(19) United States
(12) Patent Application Publication
(10) Pub. No.: US 2006/0079619 A1
(43) Pub. Date: Apr. 13, 2006

(54) Piezoelectric transducing sheet

(76) Inventors: Ruiping Wang, Ibaraki (JP); Hiroshi Sato, Ibaraki (JP); Yoshiro Shimojo, Ibaraki (JP); Tadashi Sekiya, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/539,211

(22) PCT Filed: Nov. 12, 2003
(86) PCT No.: PCT/JP03/14358

§ 371 Date: Jun. 17, 2005

(30) Foreign Application Priority Data
Dec. 19, 2002 (JP) 2002-368429

(51) Int. Cl. C08K 3/22

(52) U.S. Cl. 524/413; 252/62.9 PZ

(57) ABSTRACT

A piezoelectric sheet, which comprises a matrix comprising a polyimide, silicone rubber or an epoxy resin, and a cubic lead zirconate titanate single-crystal particle dispersed in the matrix, wherein (100) plane of said single-crystal particle is oriented parallel to a plane of said sheet, and said single-crystal particle penetrates the plane of said sheet from one to the other side. Conventionally, since the constituent crystal particles are randomly oriented, properties of the crystal particles are obtained as the average values of the properties of the individual particles. In contrast, according to the piezoelectric sheet of the present invention, since the cubic PZT single-crystal particles have been disposed so that (100) axes are oriented perpendicularly to the plane of the sheet, the PZT can have the properties inherent in the (100) planes.

### TECHNICAL FIELD

The present invention relates to a piezoelectric sheet containing cubic single-crystal particles of lead zirconate titanate (hereinafter referred to also as PZT).

### BACKGROUND ART

Piezoelectric ceramics have two effects, i.e., the direct piezoelectric effect of converting a mechanical input into an electrical output and the inverse piezoelectric effect of converting an electrical input into a mechanical output, and are used as sensors and actuators utilizing the effects in a wide range of applications.

Recently, a tendency to utilize a piezoelectric actuator for the vibration control of aircraft, motor vehicles and railway stocks, and for the seismic isolation of constructions and buildings has been increased. Hence, an expectation for actuator materials having a large displacement and a high output has been raised. Presently, most of the piezoelectric ceramics in general use comprise PZT, which is a perovskite compound, as the main component. However, the practically attainable electrical strain (ΔL/L) thereof is about 0.1%, which is insufficient for use of these piezoelectric ceramics as an actuator having a large displacement and a high output.

Recently, investigations have been enthusiastically made for the purpose of forming single-crystal piezoelectric materials to improve the piezoelectric properties by the domain operation. For example, it was shown that a Pb(Zn_{1/3}Nb_{2/3})O₃—PbTiO₃ perovskite solid solution can be obtained in a single-crystal form, and that a displacement of 1% or larger in the (100) direction can be obtained by polarizing the single-crystal solid solution having a rhombohedral structure in the (100) direction, and the results attracted a lot of attention. (S. Park, and T. R. Shrout, J. Appl. Phys., 82(1997), p. 1804 (non-patent document 1)).

On the other hand, investigations in which PZT in a thin film form is produced to use in applications such as a ferroelectric memory and a microactuator have been also enthusiastically conducted. It has been found that a thin PZT film oriented in the (100) direction shows a higher ΔL/L than that of being oriented in the (111) direction (T. Iijima, T. Abe, and N. Sanada, Proceedings of The 9th US-Japan Seminar on Dielectric & Piezoelectric Ceramics, 1999, p. 215 (non-patent document 2)). These are the domain operation on single crystals conducted by the technique, called the Engineered domain method. Recently, this operation is regarded as the key technology for improving piezoelectric properties. If PZT is obtained in a single-crystal form, there is a possibility that a larger electrical strain than in ceramics can be obtained by the application of the Engineered domain method. However, no successful case of obtaining PZT single-crystal particle which is sufficiently large for practical use has been reported. Although the technique called the lead oxide flux method is effective in obtaining single crystals of lead-containing materials in a lot of cases, the application of this technique to PZT merely gives single-crystal particles having a size around 10 μm. However, even when the single-crystal PZT is composed of such small single-crystal particles, it can be handled as single crystals if there is a technique for arranging these particles so as to be oriented in a specific direction.

The technique for the orientation of single-crystal particles has already been investigated by one of the present inventors (Tadashi Sekiya, Proceedings of the smart materials symposium, 1999, p. 65 (non-patent document 3)). This technique utilizes the fact that the PZT single-crystal particles obtained by the lead oxide flux method are characterized by having a relatively uniform cubic shape with a particle size around 100 μm. This technique comprises rolling a mixture of a liquid polystyrene resin and PZT single-crystal particles on a glass substrate to form a sheet of the mixture. As a result, many of the PZT single-crystal particles in the composite sheet are arranged, with (100) planes thereof parallel to the plane of the sheet. However, the sheet obtained in this case failed to have the ferroelectric properties of the PZT single-crystal particles, since the electrical conductivity of the polymer was higher than the properties of the PZT single-crystal particles. In order to have this sheet function as a ferroelectric/piezoelectric, the polymer matrix should have sufficiently higher insulating property than the PZT single-crystal particles. This has been a subject for future investigations.
Non-Patent Document 1: J. Appl. Phys., 82(1997), p. 1804
Non-Patent Document 2: Proceedings of The 9th US-Japan Seminar on Dielectric & Piezoelectric Ceramics, 1999, p. 215
Non-Patent Document 3: Proceedings of the smart materials symposium, 1999, p. 65

### DISCLOSURE OF THE INVENTION

The present invention has been achieved for the purpose of providing a piezoelectric sheet using cubic lead zirconate titanate single-crystal particles, which has an increased piezoelectric efficiency.

The present inventors made intensive investigations in order to accomplish the above subject. As a result, the present invention has been achieved.

Namely, the invention provides the piezoelectric sheets shown below.

(1) A piezoelectric sheet, which comprises a matrix comprising a polyimide, a silicone rubber or an epoxy resin, and a cubic lead zirconate titanate single-crystal particle dispersed in the matrix,

wherein (100) plane of said single-crystal particle is oriented parallel to a plane of said sheet, and

said single-crystal particle penetrates the plane of said sheet from one to the other side.

(2) The piezoelectric sheet according to (1), wherein a proportion of said single-crystal particle in said sheet is from 50 to 90% by volume.

### BRIEF DESCRIPTION OF THE DRAWINGS

FIG. 1 is a drawing of the production steps of the piezoelectric sheet of the present invention. Numeral 1 indicates a polymeric substance (polyimide, silicone rubber, or epoxy resin), 2 indicates a PZT single-crystal particle, 3 indicates a glass substrate, and 4 indicates a roller.

FIG. 2 is a view illustrating the structure of the piezoelectric sheet of the present invention.

FIG. 3 is an SEM photograph of PZT single-crystal particles synthesized by the lead oxide flux method in Reference Example 1 shown below.

FIG. 4 is a micrograph of the sheet of Reference Example 2 shown below, which is taken from right above.

FIG. 5 shows a comparison between the X-ray diffraction pattern for the surface of the sheet produced by using polyimide in Reference Example 2 shown below, and the X-ray diffraction pattern for the sample prepared by powdering the same single-crystal PZT.

FIG. 6 shows the measurements of changes in dielectric polarizability with applied voltage (DE loop) in the piezoelectric sheet of the present invention produced by using polyimide.

FIG. 7 shows the relationship between the thickness-directional piezoelectric strain of the piezoelectric sheet of the present invention produced by using polyimide and the applied voltage.

FIG. 8 shows the measurements of changes in dielectric polarizability with applied voltage (DE loop) in the piezoelectric sheet of the present invention produced by using silicone rubber.

### BEST MODE FOR CARRYING OUT THE INVENTION

The cubic PZT single-crystal particle used in the present invention has an edge length of single-crystal cube of around 100 μm, and is a known substance obtained by the lead oxide flux method. Each plane of this cube corresponds to (100) plane.

In regard to PZT, the PbZrO₃/PbTiO₃ molar ratio is from 40/60 to 70/30, preferably from 52/48 to 60/40.

In order to produce the piezoelectric sheet of the present invention, firstly, PZT single-crystal particles are added to and mixed with a polyimide precursor, silicone rubber precursor, or epoxy precursor, which is heat-curable and is in a liquid state or in a solution state (hereinafter, these precursors are often referred to as polymer precursors). In this mixture, the proportion of the PZT single-crystal particles is from 50 to 90% by volume, preferably from 80 to 90% by volume.

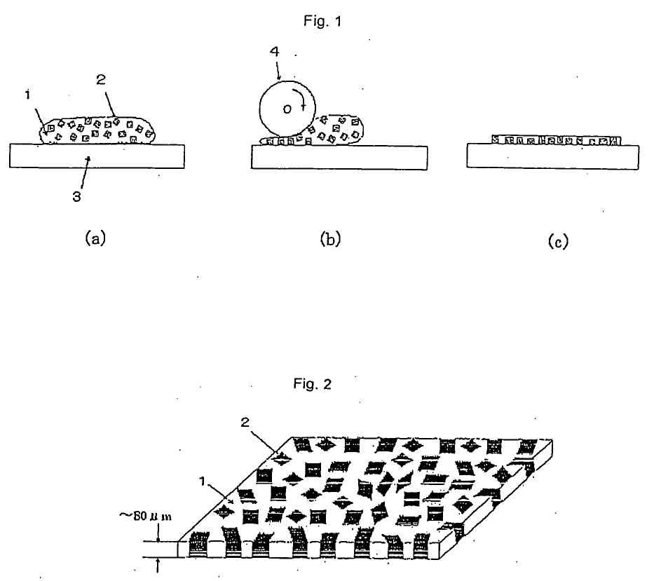

Subsequently, this mixture is placed on a substrate having a smooth surface, e.g., a glass substrate, as shown in FIG. 1 (a). The mixture is rolled as shown in FIG. 1 (b) to form on the substrate a liquid sheet in which the PZT single-crystal particles are oriented, as shown in FIG. 1 (c). Subsequently, the sheet is heated to cure the polymer precursor. Although the heating temperature varies, depending on the kind of the polymer precursor, it is generally as follows. In the case of a polyimide precursor, the heating temperature is from 150 to 270° C., preferably from 200 to 250° C. In the case of a silicone rubber precursor, the heating temperature is from 100 to 190° C., preferably from 150 to 180° C. In the case of an epoxy precursor, the heating temperature is from room temperature to 160° C., preferably from 120 to 150° C.

When a polymer containing PZT single-crystal particles is formed into a sheet in the manner described above, the single-crystal PZT is oriented, with (100) axes thereof perpendicular to the plane of the sheet, since the faces of each PZT single-crystal cube are composed of (100) planes. Furthermore, by the rolling operation, it is possible to prepare a sheet having a thickness which is the same as the size of the cubes, i.e., a sheet in which the PZT single-crystal particles penetrate the sheet from one to the other side. Accordingly, the resulting sheet is classified into the composite piezoelectrics called 1-3 type. The rolled sheet is dried and heated under appropriate conditions, and then peeled off from the substrate.

A view illustrating the structure of the piezoelectric sheet thus obtained is shown in FIG. 2.

In FIGS. 1 and 2, 1 indicates a polymeric substance, 2 indicates a cubic PZT single-crystal particle, 3 indicates a substrate, and 4 indicates a roller.

The polyimide precursor in a liquid state or in a solution state to be used in the present invention is available in the market. Usually, the precursor cures to give a solid polyimide by heating at the temperature of from 200 to 250° C. The polyimide precursor may be any polyimide precursor which is in a liquid state or in a solution state at ordinary temperature, and various known precursors may be used. Examples thereof include polyamic acid solutions (which give a polyimide by the dehydration), condensation-type polyimide precursors and addition-reaction-type polyimide precursors.

In the invention, it is especially preferable to use a polyimide precursor having a repeated structural unit represented by the following formula (1):
—(N(OC)₂C₆H₃SO₂C₆H₃(CO)₂NR)ₙ— (1)
In formula (1), R is an aryl group.

The silicone rubber precursor in a liquid state or in a solution state to be used in the present invention is available in the market. Usually, the precursor cures to give a solid silicone rubber by heating at the temperature of from 150 to 180° C. The silicone rubber precursor may be any silicone rubber precursor which is in a liquid state or in a solution state at ordinary temperature, and various known precursors may be used. Examples thereof include ones having a repeated structural unit represented by the following formula (2). Catalysts and crosslinking agents are incorporated into the silicone rubber precursor.
—(SiR₂O)ₙ— (2)
In formula (2), R is an alkyl group or an aryl group.

In addition, the epoxy resin to be used in the present invention has a repeated structural unit represented by the following formula (3). The liquid precursor of the epoxy resin is easily available as a commercial product. When an appropriate amount of a hardener is added, the precursor cures in several hours at ordinary temperature or cures in about 30 minutes by heating at the temperature of from 120 to 150° C.
-Ep[CH₂ORC(CH₃)₂ROCH₂CH(OH)CH₂O]ₙRC(CH₃)₂ROCH₂Ep- (3)
In formula (3), Ep is an epoxy group and R is an aryl group.

### EXAMPLES

The invention will be explained below in more detail by referring to Examples.

### Reference Example 1

(Production of Cubic PZT Single-Crystal Particles)

In the present invention, cubic PZT single-crystal particles are produced by the lead oxide flux method. It is known that PZT ceramics show the highest piezoelectric efficiency, when they have the composition at the phase boundary between the rhombohedral phase and the tetragonal phase (Morphotropic phase boundary, MPB; PbZrO₃/PbTiO_{3=52/48}). However, it is difficult to prepare the large single-crystal particles in the composition. Therefore, the composition of PbZrO₃/PbTiO_{3=55/45}, which is slightly abundant in the rhombohedral phase in comparison with the MPB composition, was selected as the composition of the target single crystal to be synthesized, for the purpose of obtaining crystal particles with a larger size. As starting materials, special-grade PbO, ZrO₂ and TiO₂ in the marketplace were used.

These materials were mixed in a proportion of PbO/perovskite=2/1, i.e., a composition of 3PbO+0.55ZrO_{2+0.45}TiO₂. This mixture was packed into a platinum crucible having a size of 60 mL, and heated in an electric furnace at from 1,150 to 1,200° C. for 5 hours to thereby completely melt the mixture, followed by the gradual cooling at a rate of 2° C./hr. The excess PbO was removed by dissolving in an acetic acid solution to separate PZT single-crystal particles.

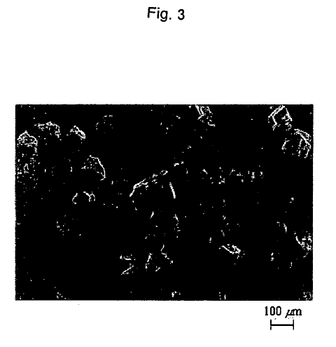

FIG. 3 is an SEM photograph of the PZT single-crystal particles obtained.

It can be seen that the cubic single-crystal particles having a relatively uniform particle size around 100 μm are formed. According to the result of X-ray diffraction, these single-crystal particles are ascertained to be PZT having a rhombohedral structure.

### Reference Example 2

A mixture of 30 parts by volume of the PZT single-crystal particles obtained in Reference Example 1 and 70 parts by volume of a liquid polyimide (trade name “Rika Coat SN-20”, manufactured by New Japan Chemical Co., Ltd.) was rolled on a glass substrate. A Teflon(R) rod was used as the roller in order to avoid adhesion of the polyimide mixture to the roller. Subsequently, the mixture was dried at 120° C. for several hours together with the glass substrate and then peeled from the glass substrate. Thus, a relatively flexible sheet was obtained.

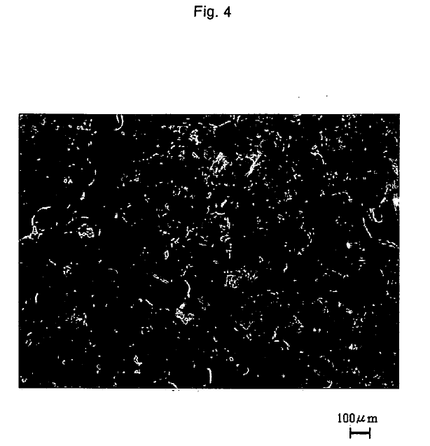

FIG. 4 shows a microphotograph of the sheet which is taken from right above. It can be seen that a considerably large number of crystal particles have been arranged, with square faces thereof faced upward.

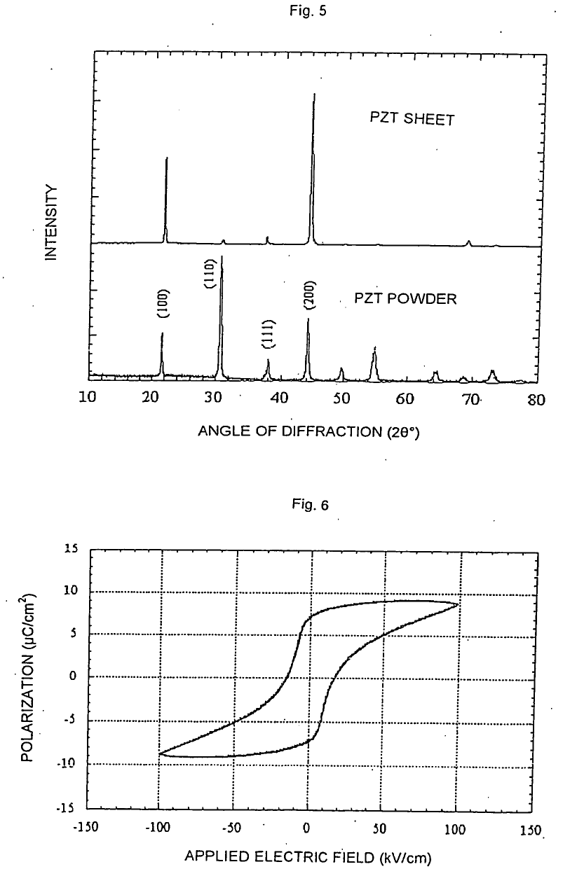

FIG. 5 shows a comparison between the X-ray diffraction pattern for the surface of the sheet and the X-ray diffraction pattern for the sample prepared by powdering the same single-crystal PZT. It can be clearly seen from the comparison between the X-ray diffraction patterns that the PZT single-crystal particles in the sheet is highly oriented with respect to (100) planes. The degree of the orientation is found to be as high as about 90%, according to the estimation using the calculation formula called the Lotgering method.

### Example 1

The sheet obtained in Reference Example 2 was heated at 250° C. to convert the polyimide resin to be highly insulated. Thereafter, the surface of the sheet was polished so that the PZT single-crystal particles buried in the polyimide resin be exposed on the sheet surface. Subsequently, both sides of the sheet were subjected to gold sputtering to conduct electrode deposition, and the dielectric/piezoelectric properties of the sheet were evaluated.

FIG. 6 shows the measurements of changes in dielectric polarizability with applied voltage (DE loop). It can be seen that the DE loop has the shape which is characteristic of ferroelectrics. However, the values of saturation polarization and remanent polarization, which are the indexes to the performances as ferroelectrics, are 9 μC/cm² and 7 μC/cm², respectively. These values are far smaller than those of PZT ceramics and thin PZT films. This is because not all the PZT single-crystal particles are exposed on the sheet surfaces and in contact with the electrodes, and it is thought that an improvement in this point can achieve a further improvement. In any event, it becomes clear that the 1-3 type composite piezoelectric sheet, which comprises PZT single-crystal particles and a polyimide, obtained by the technique according to the present invention, functions as a ferroelectric.

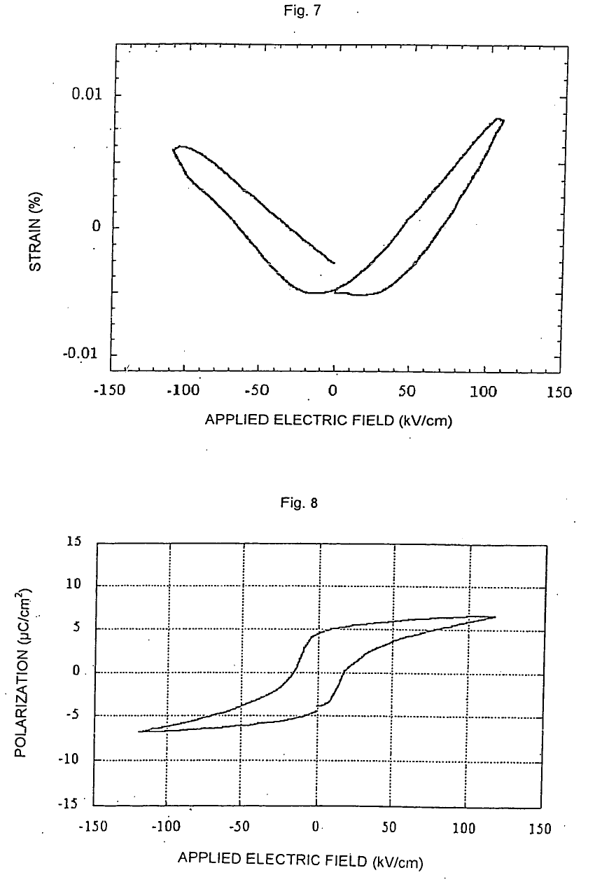

In FIG. 7, the relationship between piezoelectric strain in the sheet thickness direction and applied voltage is shown. The figure shows that the strain increases with increasing applied voltage to give a butterfly-type strain curve, which is characteristic of PZT ceramics.

### Example 2

A mixture of 30 parts by volume of the PZT single-crystal particles obtained in Reference Example 1 and 70 parts by volume of a liquid silicone rubber (trade name “HTV Type Liquid Silicone” manufactured by EITECH Co., Ltd.) was formed into a sheet in the same manner as in Reference Example 2 and Example 1.

FIG. 8 shows the measurements of changes in the dielectric polarizability of the sheet with applied voltage (DE loop). This loop has a normal shape of the ferroelectrics, and it can be seen that the composite sheet which employs a silicone rubber also functions as a piezoelectric.

### Example 3

A mixture of 30 parts by volume of the PZT single-crystal particles obtained in Reference Example 1 and 70 parts by volume of a liquid epoxy resin precursor was formed into a sheet in the same manner as in Example 1. As the measurements of the changes of the sheet in dielectric polarizability with applied voltage (DE loop), it is found out that the sheet shows the hysteresis loop characteristic of ferroelectrics, in which the saturation polarization and the remanent polarization were 8 μC/cm² and 6 μC/cm², respectively, and that the composite sheet comprising an epoxy resin also functions as a ferroelectric/piezoelectric.

### INDUSTRIAL APPLICATION FIELD

In regard to general ceramics, since the constituent crystal particles are randomly oriented, properties of the crystal particles are obtained as the average values of the properties of the individual particles. In contrast, according to the piezoelectric sheet of the present invention, since the cubic PZT single-crystal particles have been disposed so that (100) axes are oriented perpendicularly to the plane of the sheet, the PZT can have the properties inherent in the (100) planes.

Furthermore, according to the piezoelectric sheet of the present invention, the PZT single-crystal particles have a rhombohedral structure, with (100) axes thereof oriented perpendicularly to the plane of the sheet. There is hence the possibility that a large electrical strain might be obtained by applying the Engineered domain method same as in the successful case with a Pb(Zn_{1/3}Nb_{2/3})O₃—PbTiO₃ single-crystal system having a rhombohedral structure or an oriented thin PZT film. This is because, in perovskites with a rhombohedral structure, (100) axes are most suitable for the application of the engineered domain method.

The piezoelectric sheet according to the present invention is a composite with a polymer, and is flexible. Therefore, there is of no matter with the sheet even when the sheet is curved slightly. Consequently, when the sheet is used as a sensor or an actuator, it is possible to use the sheet by applying an apparatus having a curved surface.

1. A piezoelectric sheet, which comprises a matrix comprising a polyimide, a silicone rubber or an epoxy resin, and a cubic lead zirconate titanate single-crystal particle dispersed in the matrix,
wherein (100) plane of said single-crystal particle is oriented parallel to a plane of said sheet, and
said single-crystal particle penetrates the plane of said sheet from one to the other side.

2. The piezoelectric sheet according to claim 1, wherein a proportion of said single-crystal particle in said sheet is from 50 to 90% by volume.
